(19) United States
(12) Patent Application Publication
(10) Pub. No.: US 2026/0275448 A1
(43) Pub. Date: Sep. 17, 2026

(54) AN ANNEALING APPARATUS FOR A METAL STRIP COATING SYSTEM

(71) Applicant: DANIELI & C. OFFICINE MECCANICHE S.P.A., Buttrio (IT)

(72) Inventors: Luciano Vignolo, Udine (IT); Andrea Codutti, Moruzzo (IT); Marco Petronio, Monfalcone (IT); Giacomo Cozzarolo, Cividale del Friuli (IT)

(21) Appl. No.: 18/868,612

(22) PCT Filed: May 26, 2023
(86) PCT No.: PCT/IB2023/055409

§ 371 Date: Nov. 22, 2024

(30) Foreign Application Priority Data
May 26, 2022 (IT) 102022000011072

(51) Int. Cl. C21D 9/60; C21D 8/0247; C21D 9/675

(52) U.S. Cl. CPC C21D 9/60; C21D 8/0273; C21D 9/675

(57) ABSTRACT

An annealing apparatus for a metal strip advancing along a longitudinal direction into a coating system for coating said metal strip with a layer of molten metal, said apparatus comprising, in sequence:
at least one longitudinal-flow induction heating device;
at least one transverse-flow induction heating device;
at least one cooling zone.

### CROSS-REFERENCE TO RELATED APPLICATIONS

This application claims priority to PCT International Application No. PCT/IB2023/055409 filed on May 26, 2023, which applications claims priority to Italian Patent Application No. 102022000011072 filed on May 26, 2022, the entire disclosures of which are expressly incorporated herein by reference.

### STATEMENT RE: FEDERALLY SPONSORED RESEARCH/DEVELOPMENT

Not Applicable

### BACKGROUND

### Field of the invention

The present invention relates to the field of systems for coating flat bodies made of a ferromagnetic material, e.g., metal strips, in particular strips made of steel. More specifically, the invention relates to an annealing apparatus and a related process for heating and annealing a moving strip made of a ferromagnetic material before coating it with a molten metal, e.g., zinc. The present invention further relates to a system for coating a metal strip with molten metal comprising such an annealing apparatus.

### Background art

As known, strips made of a ferromagnetic material are externally coated by means of a plurality of coating processes, e.g., by zinc-coating.

The zone of the tank containing the molten metal bath, e.g., zinc, is the heart of the coating process and affects the system operation, process productivity, product quality, and zinc consumption.

The cold-rolled strips or hot-rolled and pickled strips are processed in the hot zinc-coating systems in continuous heating and annealing apparatuses. Depending on the product and quality of the incoming material and on the expected quality of the exiting material, the thermal heating cycle is defined by a maximum temperature of the material in the apparatus, a temperature maintaining time, and a strip process speed.

The annealing apparatuses, or more simply furnaces, can be divided, depending on the configuration, into horizontal, vertical or mixed furnaces, with a horizontal stretch and a vertical stretch.

The portion of the apparatus dedicated to the reheating usually consists of modules for:
Pre-heating;
Heating with an open flame by means of burners;
Heating with radiant tubes by means of burners.

A known example of a system for coating a metal strip is shown in FIG. 1. Such a system comprises an annealing apparatus, arranged upstream of the tank 8 containing the molten metal bath, provided with:
a pre-heating zone 1;
an open-flame heating device 2, arranged immediately downstream of the pre-heating zone 1 and communicating with the latter so that the fumes produced by the open-flame heating device 2 are used directly for performing the pre-heating in zone 1;
a radiant-tube heating device 4 arranged immediately downstream of said open-flame heating device 2;
a cooling zone 6,
a zone 7 provided with at least one bridle roller, which modifies the direction of the advancement path of the metal strip 9 exiting from the annealing apparatus and applies a tension to the strip, and with a connection conduit 26 between said annealing apparatus and the tank 8.

The pre-heating zone 1 is provided with an extractor 3 for extracting the fumes produced by the burners of the open-flame heating device 2, while the radiant-tube heating device 4 is provided with a further extractor 5 for extracting the fumes produced by respective burners of said radiant-tube heating device.

Some apparatuses only include the heating section with radiant tubes. In this case, it is essential to have a cleaning section upstream of the apparatus due to the lack of cleaning capacity of the open-flame heating device.

The most commonly used technology is that which uses gaseous fossil fuels, mainly natural gas. Therefore, as a result of the combustion effect, the annealing apparatus emits carbon dioxide into the atmosphere. The significant focus on reducing greenhouse gases, directly emitted by the combustion processes, results in a reconsideration of the technology used.

Heating by means of burners requires temperature rise gradients ranging from 10° C./s to a maximum of 100° C./s.

Moreover, upon changing the treatment speed or the transverse section of the sheet to be treated, the existing apparatuses have a response time of the order of tens of seconds to reach new process parameter setting conditions.

This results in greater uncertainty in maintaining the mechanical characteristics expected in the transient steps of the process, causing an increased dispersion thereof, resulting in higher costs due to the qualitative waste or increased energy consumption.

The heating speed and thermal inertia of the systems based on burners also define the metalworking of the product, imposing choices linked to an analysis of the alloy elements present in steel, for example, having a direct consequence of the production costs.

In view of the above, it is apparent that an innovative revision of the heating and annealing apparatuses of the hot-coating lines is needed in order eliminate the aforesaid drawbacks.

### SUMMARY OF THE INVENTION

It is an object of the present invention to manufacture a continuous annealing apparatus for a metal strip advancing into a coating system, which is capable of reducing as much as possible, up to almost eliminating, the direct emission of carbon dioxide into the environment.

It is another object of the invention to manufacture an annealing apparatus which allows high production flexibility and/or a significant increase in the hourly production capacity.

It is another object of the invention to carry out a related highly efficient annealing process with low environmental impact.

Therefore, the present invention aims to achieve the above-discussed objects by means of an annealing apparatus for a metal strip advancing along a longitudinal direction into a coating system for coating said metal strip with a layer of molten metal, said apparatus comprising, in sequence
at least one longitudinal-flow induction heating device;
at least one transverse-flow induction heating device;
at least one cooling zone;
wherein there is provided at least one pre-heating zone arranged upstream of said longitudinal-flow induction heating device.

A further aspect of the invention relates to a system for coating a metal strip with a layer of molten metal comprising the aforesaid annealing apparatus.

A further aspect of the invention relates to an annealing process for annealing a cold-rolled metal strip, advancing along a longitudinal direction into a coating system for coating said metal strip with a layer of molten metal, the process being carried out by the aforesaid apparatus and comprising the following steps:
a) heating the metal strip by means of said at least one longitudinal-flow induction heating device, at a temperature lower than the Curie temperature of the material of the metal strip;
b) heating the metal strip by means of said at least one transverse-flow induction heating device, at a temperature higher than the Curie temperature of the material of the metal strip;
c) cooling the metal strip by means of said at least one cooling zone;
wherein a pre-heating of the metal strip is provided in said at least one pre-heating zone upstream of said longitudinal-flow induction heating device.

Other advantages of some embodiments of the invention include:
high production flexibility regardless of the horizontal or vertical configuration of the annealing apparatus;
a significant increase in the hourly production capacity, in particular in the case of a combined use of inductors and gas burners;
the possibility of heating ramps, unobtainable using only the gas burners, allows producing qualities of steel, with the same mechanical characteristics, simplified chemicals and with an evident benefit to the production costs;
the combined use of inductors of a different type, or inductors of a different type and burners, allows eliminating potential differences between center and edge of the strip;
the use of the open flame together with the inductor allows obtaining the surface cleaning without needing to add a cleaning section upstream of the annealing apparatus.

The dependent claims describe preferred embodiments of the invention.

### BRIEF DESCRIPTION OF THE DRAWINGS

Further features and advantages of the invention will become more apparent in the light of the detailed description of preferred, but not exclusive, embodiments of an apparatus shown by way of non-limiting example, with the aid of the accompanying drawings, in which:

FIG. 1 shows a diagram of a strip coating system with annealing apparatus according to the prior art;

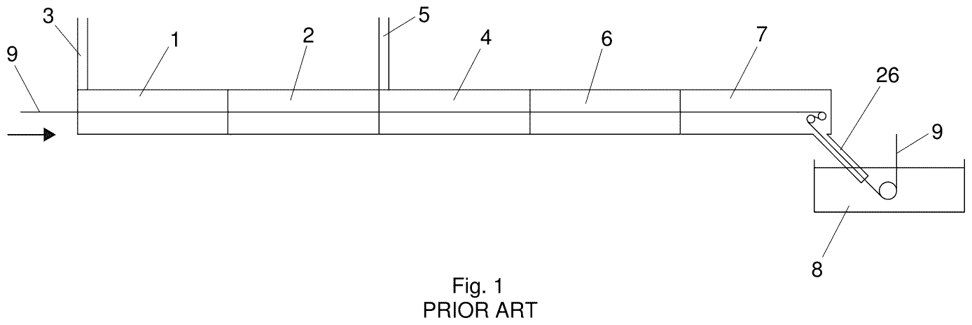

FIG. 2 shows a diagram of a strip coating system with a first embodiment of the annealing apparatus according to the invention;

FIG. 3 shows a diagram of a first component of the annealing apparatus in FIG. 2;

FIG. 4 shows a diagram of a second component of the annealing apparatus in FIG. 2;

FIG. 5 shows a diagram of a strip coating system with a second embodiment of the annealing apparatus according to the invention;

FIG. 5a shows a first variant of the second embodiment in FIG. 5;

FIG. 5b shows a second variant of the second embodiment in FIG. 5;

FIG. 5c shows a third variant of the second embodiment in FIG. 5;

FIG. 6 shows a diagram of a strip coating system with a third embodiment of the annealing apparatus according to the invention;

FIG. 6a shows a first variant of the third embodiment in FIG. 6;

FIG. 6b shows a second variant of the third embodiment in FIG. 6;

FIG. 6c shows a third variant of the third embodiment in FIG. 6.

The same reference numbers in the figures identify the same elements or components.

### DETAILED DESCRIPTION OF PREFERRED EMBODIMENTS OF THE INVENTION

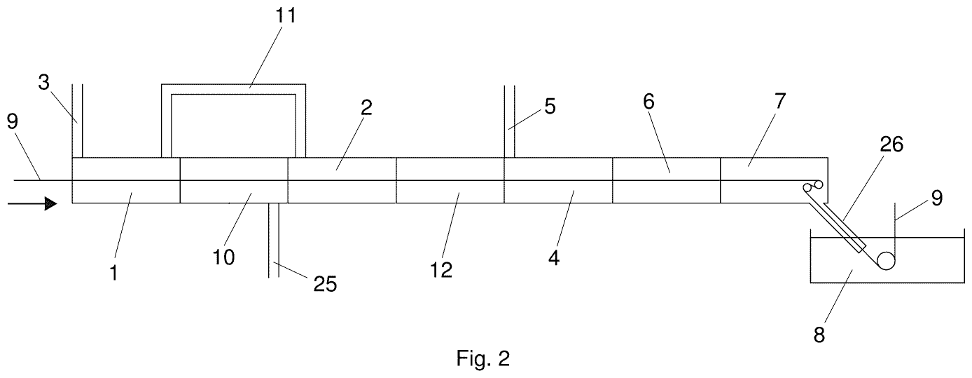

Some exemplary embodiments of part of a system for coating a metal strip 9 with a layer of molten metal are described with reference to FIGS. 2 to 6, the system comprising an annealing apparatus according to the invention. As known, the metal strip is a product having a dimension, i.e., thickness, significantly smaller than the other two dimensions, i.e., length and width.

In all embodiments of the invention, the annealing apparatus for a metal strip 9, advancing along a longitudinal direction into said coating system, comprises in sequence
at least one longitudinal-flow induction heating device 10;
at least one transverse-flow induction heating device 12;
and at least one cooling zone 6.

Advantageously, the longitudinal-flow induction is applied for ferromagnetic materials, therefore below the Curie temperature. Above the Curie temperature, the material becomes non-magnetic and advantageously, transverse-flow induction is used.

The contrary, instead, would lead to a bad energy output with a very low energy transfer to the strip. Moreover, a transverse flow applied to ferromagnetic material would attract the strip with the risk of touching the induction coils.

Advantageously, there is provided at least one pre-heating zone 1, 27, 32, 33 arranged upstream of the longitudinal-flow induction heating device, for pre-heating the strip, preferably by means of a recovery of heat from the same annealing apparatus or from a further production apparatus cooperating with said annealing apparatus by means of a heat transfer fluid.

In some variants of the apparatus, only one longitudinal-flow induction heating device 10 is provided and only one transverse-flow induction heating device 12 is provided.

For example, the coating system is a hot zinc-coating line for treating pickled or cold-rolled steel strips, such as:
strips made of low, medium or high carbon steel;
strips made of micro-alloyed steel;
strips made of Interstitial Free High Strength Steel (IFHSS);
strips made of Advanced High Strength Steel (AHSS);
strips made of ferritic stainless steel.

Advantageously, a first embodiment of the apparatus of the invention includes the combined use of inductive heating systems and heating systems, preferably provided with burners, supplied with combustible gas.

In this case, the heating and annealing of the strip are carried out by combining thermal energy applied through inductive systems, by virtue of the Joule effect due to the eddy currents induced by the magnetic fields, and thermal energy from combustion.

This first embodiment of the apparatus of the invention comprises, or consists of, in sequence (FIG. 2):
a pre-heating zone 1, preferably being a pre-heating tunnel;
at least one longitudinal-flow induction heating device 10;
an open-flame heating device 2;
at least one transverse-flow induction heating device 12, which brings the strip to a target temperature or final annealing temperature.

The open-flame heating device 2 is provided with burners, preferably supplied with natural gas, the flame of which directly touches the strip making the temperature of the strip uniform, also transversely.

It is possible to control the ratio between air and combustible gas so as to have an excess of combustible (combustion above stoichiometric) and produce reducing fumes due to the carbon monoxide, which improve the surface cleaning of the strip, eliminating oily residues, iron powder, and oxides.

Advantageously, the combined use of the longitudinal-flow induction heating device 10 and the open-flame heating device 2, at a minimum power level to obtain the surface cleaning effects, allows a significant reduction in direct carbon dioxide emissions, with the production capacity being the same, e.g., a reduction from −30 to −50% in carbon dioxide emissions as compared to the solutions of the prior art.

Preferably, the radiant-tube heating device 4 is arranged downstream of said at least one transverse-flow induction heating device 12, for efficiently completing the annealing cycle, also ensuring the temperature maintaining time, so that the crystallization cycle of the strip material is completed.

The radiant-tube heating device 4 can also be provided with burners, preferably supplied with natural gas.

The fumes produced by the burners of the radiant-tube heating device 4 are preferably conveyed to a discharge chimney through a special extraction conduit 5.

Advantageously, the combined use of the longitudinal-flow inductive heating system and the transverse-flow induction heating system with a reduced use of the open-flame heating device and the radiant-tube heating device supplied with gas, allows a significant reduction in direct carbon dioxide emissions, with the production capacity being the same, e.g., a reduction from −60 to −80% in carbon dioxide emissions as compared to the solutions of the prior art.

Downstream of the at least one transverse-flow induction heating device 12 or downstream of the radiant-tube heating device 4, if present, there is arranged a cooling zone 6, followed by a zone 7 provided with at least one bridle roller, which modifies the direction of the advancement path of the metal strip 9 exiting from the annealing apparatus and applies a tension to the strip, and with a connection conduit 26 between the annealing apparatus and the tank 8.

Preferably, there is provided a conduit 11 for conveying the fumes produced by the open-flame heating device 2 to the pre-heating zone 1, said conduit 11 bypassing the longitudinal-flow induction heating device 10. In the pre-heating zone 1, the fumes pass in countercurrent with respect to the strip advancement direction.

The bypass conduit 11 only comes into operation when both the longitudinal-flow induction heating device 10 and the open-flame heating device 2 are in operation.

The fumes produced by the burners of the open-flame heating device 2 are preferably conveyed to a discharge chimney through a special extraction conduit 3 arranged in the pre-heating zone 1, preferably at the distal end thereof from the longitudinal-flow induction heating device 10.

Advantageously, this first embodiment allows
modernizing existing apparatuses without completely reconstructing the annealing furnace, but containing the part producing the maximum emission of carbon dioxide;
reducing the CAPEX and the stops for modifying the apparatus;
reducing energy consumption by virtue of the recovery of heat of the fumes generated by the open-flame heating device;
obtaining a surface cleaning of the strip by means of said open flame.

Moreover, it is possible to improve the characteristics of the product in the transients with constant power combustion and variable power inductors, by taking advantage of the shorter response time of the inductors.

A second embodiment of the apparatus of the invention advantageously includes the exclusive use of inductive heating systems, and therefore the exclusive use of thermal energy applied through inductive systems, as an alternative to thermal combustion energy.

In this case, the heating and annealing of the strip are carried out exclusively by virtue of the Joule effect due to the eddy currents induced by the magnetic fields. Therefore, advantageously, the complete elimination of carbon dioxide emissions is obtained.

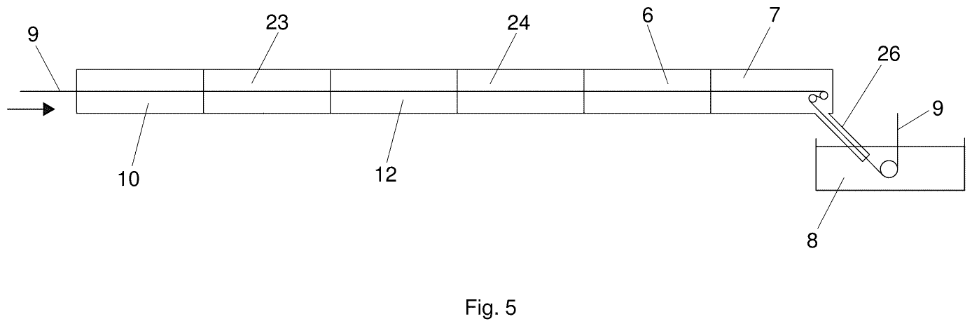

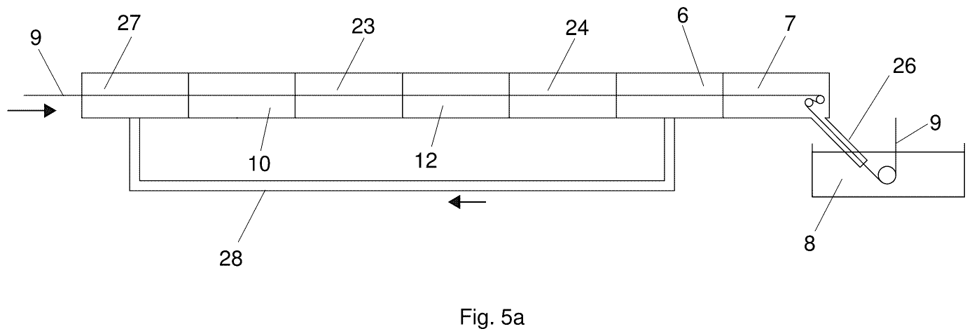

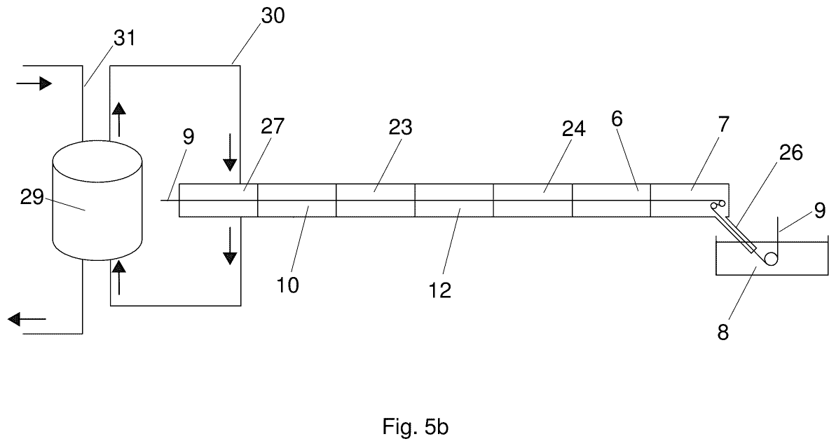

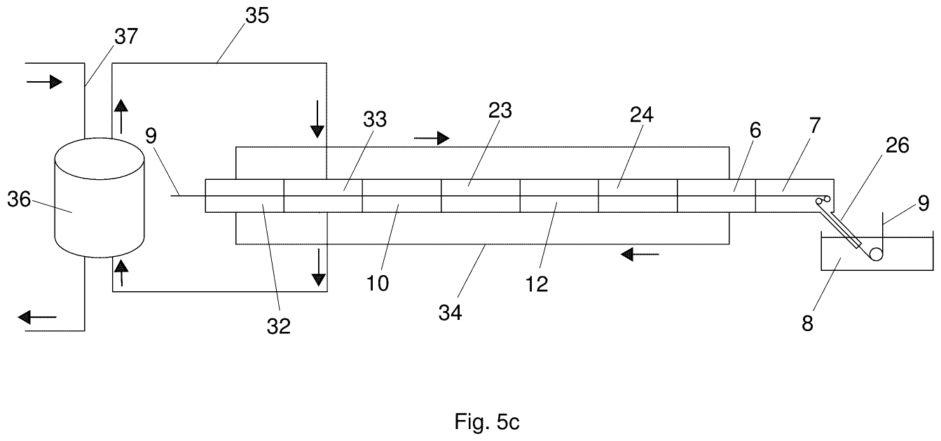

This second embodiment of the apparatus of the invention comprises, or consists of, in sequence (FIG. 5):
at least one longitudinal-flow induction heating device 10,
a compensation zone 23 for making the temperature uniform of the strip exiting from said at least one longitudinal-flow induction heating device 10, in both a longitudinal direction and a transverse direction;
at least one transverse-flow induction heating device 12, which brings the strip to a target temperature or final annealing temperature;
and a maintaining zone 24 for maintaining the strip at said target temperature.

The compensation zone 23 can be passive, without the supply of thermal energy to the strip, or active, with the supply of thermal energy to the strip.

The maintaining zone 24 is an active zone instead, with a supply of thermal energy to the strip, and it allows maintaining the final annealing temperature for the residence time required by the metalworking recipe.

Preferably, the maintaining zone 24 and optionally also the compensation zone 23 are provided with electric radiant elements, respectively.

These electric radiant elements can be resistor spark plugs or tubes, for example.

Downstream of the maintaining zone 24 there is arranged a cooling zone 6, followed by a zone 7 provided with at least one bridle roller, which modifies the direction of the advancement path of the metal strip 9 exiting from the annealing apparatus and applies a tension to the strip, and with a connection conduit 26 between the annealing apparatus and the tank 8.

The at least one transverse-flow induction heating device 12, the maintaining zone 24 and the cooling zone 6 can be kept pressurized by means of a technical gas flow, preferably a single flow of technical gas, such as nitrogen and/or hydrogen, for example, which ensures protection from oxidation, e.g., by means of nitrogen, and a cleaning/reducing action, e.g., by means of hydrogen. The technical gas is heated up to the maintaining zone 24 to be then used at a low temperature in the cooling zone.

A first variant of this second embodiment is shown in FIG. 5a. Advantageously, a pre-heating zone 27 is provided upstream of the at least one longitudinal-flow induction heating device 10.

One conduit 28 connects the cooling zone 6 to the pre-heating zone 27 for conveying part of the technical gas, at a temperature from 150 to 180° C., for example, to said pre-heating zone 27 for pre-heating the strip entering at room temperature.

A second variant of this second embodiment is shown in FIG. 5b. Advantageously, a pre-heating zone 27 is provided upstream of the at least one longitudinal-flow induction heating device 10.

A conduit 30 crosses the pre-heating zone 27 for pre-heating the strip by means of a heat transfer fluid carried by said conduit 30.

For example, a heat exchanger 29 is provided, outside the pre-heating zone, which is crossed by the conduit 30 for heating, in turn, the heat transfer fluid, by recovering heat from a further heat transfer fluid carried by a discharge conduit 31 of any further production apparatus. The discharge conduit 31 can also cross the heat exchanger 29.

By way of non-limiting example, the heat transfer fluid can be steam coming from a water-exchanger where it recovers heat from the further heat transfer fluid, which can consist, for example, of the fumes of an electric arc furnace or a heating furnace, etc. In this case, the strip can go from room temperature to a temperature of about 90°, or even about 200° C. if the steam is pressurized.

A third variant of this second embodiment is shown in FIG. 5c. Advantageously, there are provided two pre-heating zones 32, 33 upstream of the at least one longitudinal-flow induction heating device 10.

A conduit 34 connects the cooling zone 6 to the first pre-heating zone 32 for conveying part of the technical gas, e.g., at a temperature from 150 to 180° C., in said first pre-heating zone 32 for pre-heating the strip entering at room temperature.

Preferably, the conduit 34 crosses the first pre-heating zone 32 and goes back to the cooling zone 6.

For example, the technical gas reaches the first pre-heating zone 32 with a jet cooler system at a temperature of 150-180° C. and exchanges heat with the incoming strip by convective effect. The strip can be heated from room temperature to a temperature in a range from 100 to 120° C.

The second pre-heating zone 33 is arranged downstream of the first pre-heating zone 32, preferably immediately downstream.

A conduit 35 crosses the second pre-heating zone 33 for further pre-heating the strip by means of a heat transfer fluid carried by said conduit 35.

For example, a heat exchanger 36 is provided, outside the pre-heating zones, which is crossed by the conduit 35 for heating, in turn, the heat transfer fluid, by recovering heat from a further heat transfer fluid carried by a discharge conduit 37 of any further production apparatus. Also the discharge conduit 37 can cross the heat exchanger 36.

By way of non-limiting example, the heat transfer fluid can comprise molten salts or supercritical carbon dioxide, which are heated, preferably at a temperature higher than, or equal to 600° C., by means of a heat-exchanger or a thermal energy storage (TES) 36, i.e., a component having the task of storing the thermal energy produced in excess by a generator, even discontinuously, and capable of returning it to users when required.

Alternatively, the heat transfer fluid can be of any suitable type for the purpose of pre-heating the strip, while molten salts or supercritical carbon dioxide are used in the thermal energy storage 36.

The thermal energy generator is outside the annealing apparatus and comprises, for example, an electric arc furnace (EAF), solar parables, etc.

The further heat transfer fluid can consist, for example, of the fumes of an electric arc furnace or of a heating furnace, or of steam.

A thermal energy storage or TES 36 could be provided, for example, between an outer EAF-TES loop and a TES-annealing apparatus loop.

In this second pre-heating zone 33 the strip can be heated from a temperature in a range from 100 to 120° C., reached in the first pre-heating zone 32, to a temperature in a range from 450 to 500° C., e.g., by radiation or convection.

With the three variants in FIGS. 5a, 5b and 5c it is possible to save energy by promoting the action of the next sections of the annealing system and possibly reduce the dimensions thereof.

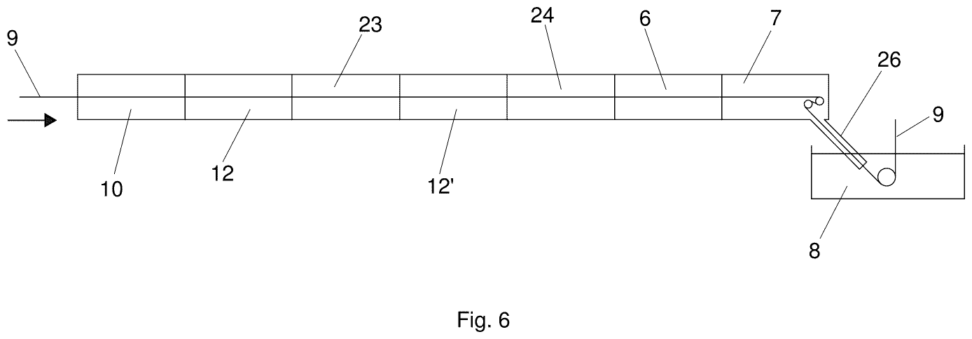

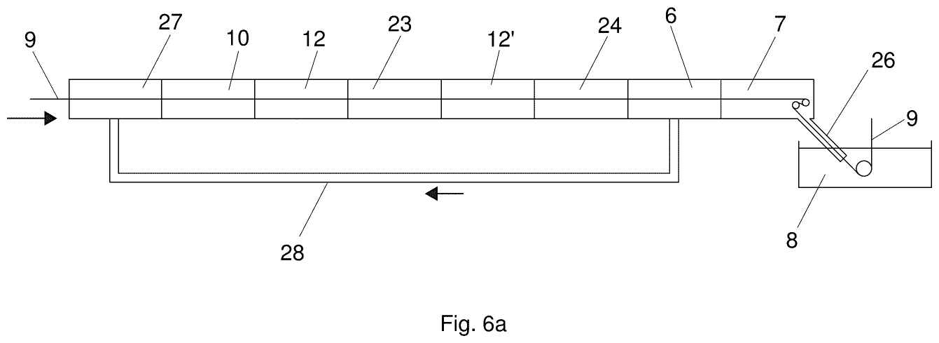

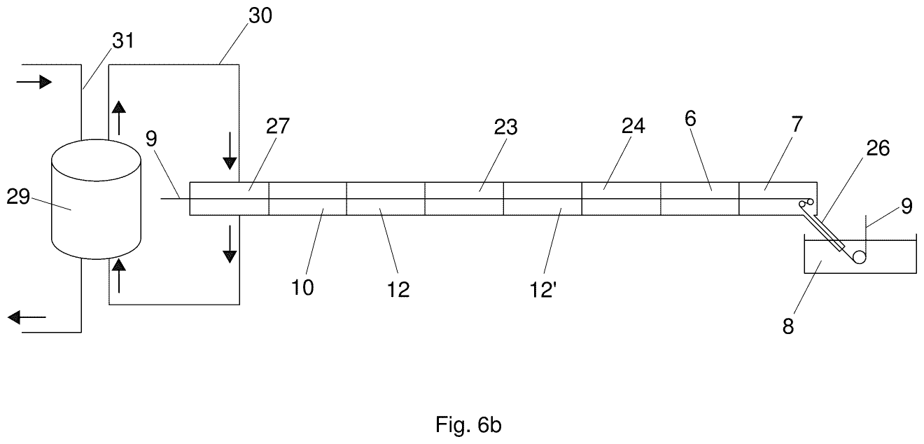

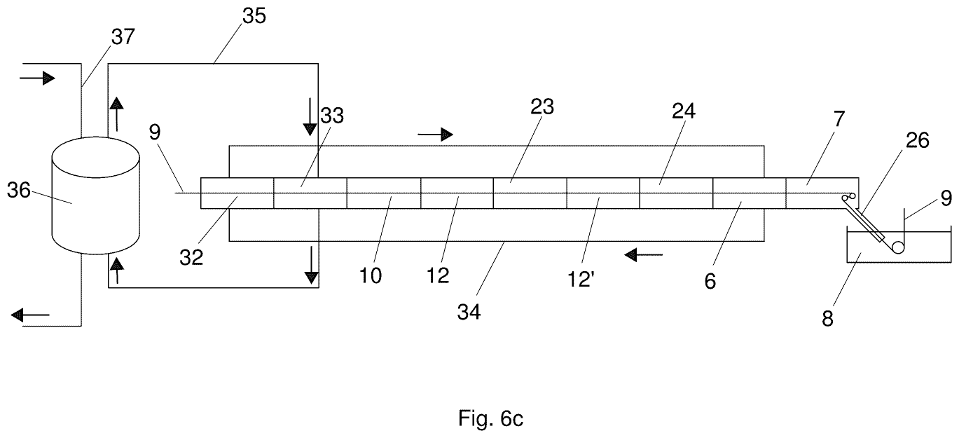

A third embodiment of the apparatus of the invention, which uses inductive heating systems as the second embodiment, comprises, or consists of, in sequence (FIG. 6):
at least one longitudinal-flow induction heating device 10,
at least one first transverse-flow induction heating device 12,
a compensation zone 23 for making the temperature uniform, in both a longitudinal direction and a transverse direction,
at least one second transverse-flow induction heating device 12′, which brings the strip to a target temperature or final annealing temperature;
and a maintaining zone 24 for maintaining the strip at said target temperature.

The compensation zone 23 can be passive, without the supply of thermal energy to the strip, or active, with the supply of thermal energy to the strip. It aims at making the temperature uniform, particularly in a transverse direction, since the at least one first transverse-flow induction heating device 12 produces an over-heating at the edges of the strip.

The maintaining zone 24 is an active zone instead, with a supply of thermal energy to the strip, for maintaining the final annealing temperature for the residence time required by the metalworking recipe so as to obtain the desired grain dimensions.

Preferably, the maintaining zone 24 and possibly also the compensation zone 23 are provided with electric radiant elements, respectively.

These electric radiant elements can be resistor spark plugs or tubes, for example.

Downstream of the maintaining zone 24, there is arranged a cooling zone 6, followed by a zone 7 provided with at least one bridle roller, which modifies the direction of the advancement path of the metal strip 9 exiting from the annealing apparatus and applies a tension to the strip, and with a connection conduit 26 between the annealing apparatus and the tank 8.

The at least one first transverse-flow induction heating device 12, the compensation zone 23, the at least one second transverse-flow induction heating device 12′, the maintaining zone 24 and the cooling zone 6 can be kept pressurized by means of a technical gas flow, preferably a single flow of technical gas, such as nitrogen and/or hydrogen, for example, which ensures protection from oxidation, e.g., by means of nitrogen, and a cleaning/reducing action, e.g., by means of hydrogen. The technical gas is heated up to the maintaining zone 24 to be then used at a low temperature in the cooling zone.

A first variant of this third embodiment is shown in FIG. 6a. Advantageously, a pre-heating zone 27 is provided upstream of the at least one longitudinal-flow induction heating device 10.

One conduit 28 connects the cooling zone 6 to the pre-heating zone 27 for conveying part of the technical gas, at a temperature from 150 to 180° C., for example, in said pre-heating zone 27 for pre-heating the strip entering at room temperature.

A second variant of this third embodiment is shown in FIG. 6b. Advantageously, a pre-heating zone 27 is provided upstream of the at least one longitudinal-flow induction heating device 10.

A conduit 30 crosses the pre-heating zone 27 for pre-heating the strip by means of a heat transfer fluid carried by said conduit 30.

For example, a heat exchanger 29 is provided, outside the pre-heating zone, which is crossed by the conduit 30 for heating, in turn, the heat transfer fluid, by recovering heat from a further heat transfer fluid carried by a discharge conduit 31 of any further production apparatus. Also the discharge conduit 31 can cross the heat exchanger 29.

By way of non-limiting example, the heat transfer fluid can be steam coming from a water-exchanger where it recovers heat from the further heat transfer fluid, which can consist, for example, of the fumes of an electric arc furnace or a heating furnace, etc. In this case, the strip can go from room temperature to a temperature of about 90°, or even about 200° C. if the steam is pressurized.

A third variant of this third embodiment is shown in FIG. 6c. Advantageously, two pre-heating zones 32, 33 are provided upstream of the at least one longitudinal-flow induction heating device 10.

A conduit 34 connects the cooling zone 6 to the first pre-heating zone 32 for conveying part of the technical gas, e.g., at a temperature from 150 to 180° C., in said first pre-heating zone 32 for pre-heating the strip entering at room temperature.

Preferably, the conduit 34 crosses the first pre-heating zone 32 and goes back to the cooling zone 6.

For example, the technical gas reaches the first pre-heating zone 32 with a jet cooler system at a temperature of 150-180° C. and exchanges heat with the incoming strip by convective effect. The strip can be heated from room temperature to a temperature in a range from 100 to 120° C.

The second pre-heating zone 33 is arranged downstream of the first pre-heating zone 32, preferably immediately downstream.

A conduit 35 crosses the second pre-heating zone 33 for further pre-heating the strip by means of a heat transfer fluid carried by said conduit 35.

For example, a heat exchanger 36 is provided, outside the pre-heating zones, which is crossed by the conduit 35 for heating, in turn, the heat transfer fluid, by recovering heat from a further heat transfer fluid carried by a discharge conduit 37 of any further production apparatus. Also the discharge conduit 37 can cross the heat exchanger 36.

By way of non-limiting example, the heat transfer fluid can comprise molten salts or supercritical carbon dioxide which are heated, preferably at a temperature higher than, or equal to 600° C., by means of a heat-exchanger or a thermal energy storage (TES) 36, i.e., a component having the task of storing thermal energy produced in excess by a generator, even discontinuously, outside the annealing apparatus.

Alternatively, the heat transfer fluid can be of any suitable type for the purpose of pre-heating the strip, while molten salts or supercritical carbon dioxide are used in the thermal energy storage 36.

The thermal energy generator, which is outside the annealing apparatus, comprises, for example, an electric arc furnace (EAF) or solar parables, etc.

The further heat transfer fluid can consist, for example, of the fumes of an electric arc furnace or of a heating furnace, or of steam.

A thermal energy storage or TES 36 could be provided, for example, between an outer EAF-TES loop and a TES-annealing apparatus loop.

In this second pre-heating zone 33 the strip can be heated from a temperature in a range from 100 to 120° C., reached in the first pre-heating zone 32, to a temperature in a range from 450 to 500° C., e.g., by radiation or convection.

With the three variants in FIGS. 6a, 6b and 6c it is possible to save energy by promoting the action of the next sections of the annealing system and possibly reduce the dimensions thereof.

In both the second and third embodiments of the invention, in the possible absence of the one or more pre-heating zones, upstream of the at least one longitudinal-flow induction heating device 10 there is provided a cleaning section, e.g., an alkaline cleaning section, for a surface cleaning of the strip, carried out instead by the open-flame heating device in the first embodiment.

Advantageously, the combined use of the longitudinal-flow induction system and the transverse-flow induction system with the aforesaid compensation and maintaining zones allows the elimination of direct carbon dioxide emissions into the environment, with the production capacity being the same.

In both the second and third embodiments, the apparatus can also be entirely pressurized by technical gases, such as nitrogen, hydrogen or a mixture thereof, ensuring protection from oxidation and a cleaning/reducing action.

In all embodiments of the annealing apparatus of the invention, the at least one longitudinal-flow induction heating device 10 can comprise at least one induction coil 14, e.g., only one induction coil, wrapped transversely about an advancement plane of the strip, i.e., transversely about a portion of the strip advancement path.

Both upstream and downstream of said at least one induction coil 14, a respective pair of guide rollers 13 is provided, preferably coated with a ceramic material for guiding and supporting the strip.

The two pairs of guide rollers 13 isolate the longitudinal-flow induction heating device 10 from the other sections, adjacent thereto, of the annealing apparatus.

Preferably, the longitudinal-flow induction heating device 10 is pressurized with a nitrogen supply line 25, to prevent the strip from oxidizing in the presence of oxygen, due to the temperature.

Optionally, temperature sensors 17 are provided for detecting the temperature of the strip entering into and exiting from said longitudinal-flow induction heating device 10.

Preferably, the at least one induction coil 14 is connected to a capacitor bank 15 and to a high-frequency converter 16.

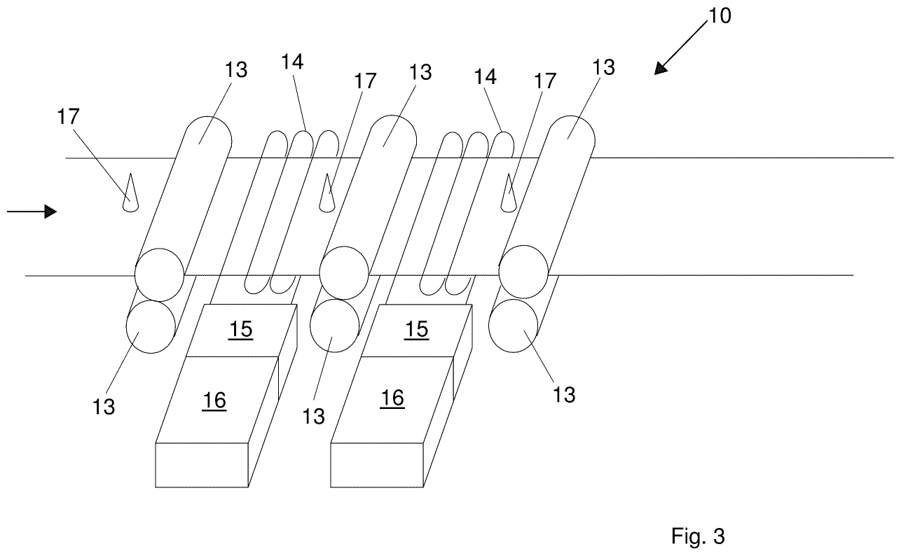

In the example in FIG. 3, the longitudinal-flow induction heating device 10 comprises, or consists of, two inductive heating modules.

Each inductive heating module comprises, or consists of, at least one induction coil 14, e.g., only one induction coil wrapped about a respective portion of the strip advancement path.

Each inductive heating module is delimited by two pairs of guide rollers 13, one upstream and the other downstream of the respective induction coil 14.

A first temperature sensor 17 is arranged upstream of the first pair of rollers 13, while a second temperature sensor 17 is arranged between the induction coil 14 and the second pair of rollers 13.

The second temperature sensor 17 of the first inductive heating module corresponds to the first temperature sensor 17 of the second inductive heating module.

Therefore, in this example, there are provided three pairs of guide rollers 13, with the central pair of rollers in common with the two inductive heating modules, and the two pairs of end rollers isolating the longitudinal-flow induction heating device 10 from the other sections, adjacent thereto, of the annealing apparatus.

Each induction coil 14 is connected to a respective capacitor bank 15 and to a respective high-frequency converter 16.

A transverse-flow induction heating device 12, 12′ can comprise instead at least one pair of induction coils 18, 19, e.g., only one pair of induction coils, consisting of a first induction coil 18, arranged at a first side of a strip advancement plane, and a second induction coil 19, arranged at a second side of said strip advancement plane, opposite to the first side.

Preferably, the transverse-flow induction heating device 12 is pressurized with a nitrogen and hydrogen supply line, to prevent the strip from oxidizing in the presence of oxygen, due to the high temperature.

The same nitrogen and hydrogen atmosphere can be used in any radiant-tube heating device 4 of the first embodiment.

Preferably, position sensors 21 are provided, e.g., of the optical or inductive type, for detecting the position of the edges of the strip with respect to a center line of the strip advancement path.

Optionally, in order to better orient the magnetic field, it is possible to control the position of the induction coils with respect to the edges of the strip. For example, at least one movement actuator 22 is provided for moving at least one of the first induction coil 18 and the second induction coil 19 transversely to the longitudinal advancement direction.

Alternatively, the first induction coil 18 and the second induction coil 19 are kept fixed, and in order to better orient the magnetic field, at least one movement actuator 22 is adapted to move screens made of copper or another suitable material, preferably arranged above the first induction coil 18 and below the second induction coil 19, respectively, so as to follow the position of the strip edge.

For example, two movement actuators 22 are provided, each actuator being configured to move the respective induction coil 18 or 19, or the respective screen (not shown), transversely to the longitudinal advancement path of the strip.

This adjustment of the position of the induction coils 18, 19, or of the position of the screens, is useful in case of a non-uniformity of the temperature profile of the strip, or in case of a transverse displacement of the strip with respect to the center line of the advancement plane path, or in case of a width change of the strip.

Pairs of guide rollers 13′ can also be provided in the transverse-flow induction heating device 12, preferably coated with a ceramic material, for guiding and supporting the strip upstream and downstream of said at least one pair of induction coils 18, 19.

Preferably, temperature sensors 17′, 20 are provided to detect the temperature of the strip entering into and exiting from said transverse-flow induction heating device 12.

Both the first induction coil 18 and the second induction coil 19 can be separately connected to a respective capacitor bank 15′ and to a respective high-frequency converter 16′.

Preferably, the two capacitor bank-converter assemblies are arranged at the two sides of the advancement plane path, i.e., one assembly at each side.

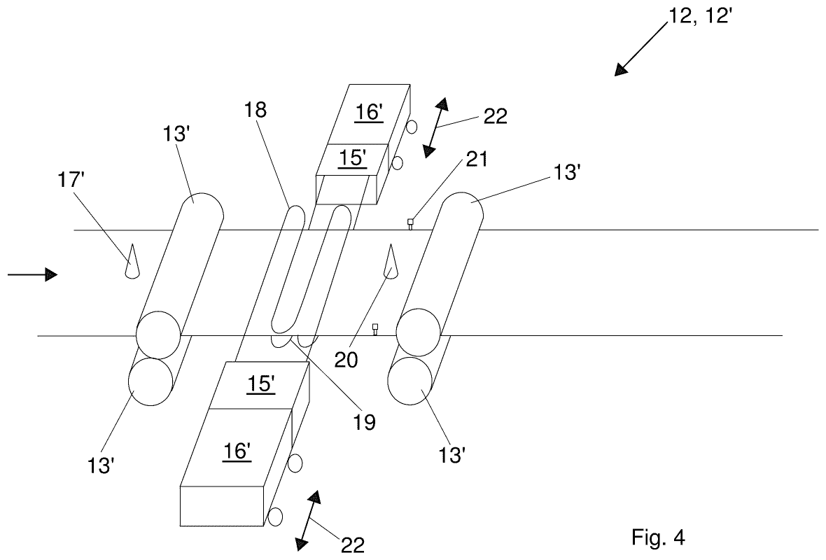

In the example in FIG. 4, the transverse-flow induction heating device 12 comprises, or consists of, a single inductive heating module consisting of only one pair of induction coils 18, 19.

This inductive heating module is delimited by two pairs of guide rollers 13′, one upstream and the other downstream of the pair of induction coils 18, 19. A first temperature sensor 17′ is arranged upstream of the first pair of rollers 13′, while a second temperature sensor 20 is arranged between the pair of induction coils 18, 19 and the second pair of rollers 13′.

In the various embodiments, all the temperature sensors 17, 17′, 20 can be pyrometers, e.g., pyrometers of the scan type for measuring the thermal profile of the strip.

In addition to the temperature sensors, along the different devices of the system of the invention, one or more of the following sensors can be present:
sensors for detecting the composition of the atmosphere (O₂, N₂, H₂, Dew point, CO₂, CO, etc.);
sensors for detecting the flow rate of combustion air, combusted fumes, N₂, H₂ and mixtures thereof;
sensors for detecting the consumption of natural gas and electricity.

Some examples of the annealing process carried out using the above-described embodiments of the apparatus are described below.

With all the embodiments of the apparatus of the invention, the process for annealing a pickled or cold-rolled metal strip 9, advancing along a longitudinal direction into a coating system for coating the metal strip with a layer of molten metal, comprises the following steps:
a) heating the metal strip, by means of at least one longitudinal-flow induction heating device 10, at a temperature lower than the Curie temperature of the material of the metal strip;
b) heating the metal strip by means of at least one transverse-flow induction heating device 12, 12′, at a temperature higher than the Curie temperature of the material of the metal strip;
c) cooling the metal strip by means of at least one cooling zone 6.

Advantageously, a pre-heating of the metal strip is provided in at least one pre-heating zone 1, 27, 32, 33 upstream of the longitudinal-flow induction heating device 10.

In both step a) and step b), the heating gradient can vary from 50 to 500° C./s, preferably from 100 to 500° C./s, even more preferably from 110 to 450° C./s.

Preferably, the at least one longitudinal-flow induction heating device 10 is kept pressurized by means of a nitrogen flow fed by the nitrogen supply line 25; while the at least one transverse-flow induction heating device 12, 12′ is kept pressurized by means of a flow of a mixture of nitrogen and hydrogen, fed by a respective supply line.

When using the first embodiment of the heating and annealing apparatus, shown in FIG. 2, the fumes produced by the open-flame heating device 2 are conveyed through the bypass conduit 11 directly into the pre-heating tunnel 1 for pre-heating the pickled or cold-rolled strip, from room temperature to a temperature in a range from 50 to 200° C., preferably from 100 to 200° C., even more preferably from 150 to 200° C. The fumes are then extracted from the pre-heating tunnel 1 by the extraction conduit 3.

Downstream of the pre-heating tunnel 1, preferably immediately downstream of the pre-heating tunnel 1, the strip is heated by means of the longitudinal-flow induction heating device 10, at a temperature lower than the Curie temperature of the material of the strip.

For example, the strip, preferably made of low carbon steel or stainless steel of the ferritic type, is heated at a temperature in a range from 500 to 650° C., preferably from 550 to 600° C., with a heating gradient from 50 to 500° C./s, preferably from 100 to 500° C./s.

Downstream of the longitudinal-flow induction heating device 10, preferably immediately downstream of the device 10, the strip is heated by means of the open-flame heating device 2, preferably supplied with natural gas, at a temperature in a range from 650 to 750° C., preferably from 670 to 730° C., e.g., up to 700° C., with a heating gradient from 30 to 100° C./s.

Downstream of the open-flame heating device 2, preferably immediately downstream of the device 2, the strip is heated by means of the transverse-flow induction heating device 12 at a temperature higher than the Curie temperature of the material of the strip.

For example, the strip is heated at a temperature in a range from 740 to 950° C., preferably from 750 to 950° C., even more preferably from 800 to 900° C., with a heating gradient from 50 to 500° C./s, preferably from 100 to 500° C./s.

Preferably, the transverse-flow induction heating device 12 is activated when the temperature of the strip exiting from the open-flame heating device 2 is close to the Curie temperature.

Optionally, downstream of the transverse-flow induction heating device 12, preferably immediately downstream of the device 12, the strip is heated by means of the radiant-tube heating device 4, preferably supplied with natural gas, to maintain a temperature in a range from 750 to 950° C., preferably from 780 to 920° C., for making the temperature uniform in the direction transverse to the strip and completing the annealing of the strip, obtaining the required mechanical properties.

In a particular variant of the process, the strip is heated
by means of the longitudinal-flow induction heating device 10 at a temperature in a range from 550 to 600° C.,
by means of the open-flame heating device 2 at a temperature in a range from 670 to 730° C.,
by means of the transverse-flow induction heating device 12 at a temperature in a range from 750 to 950° C.,
preferably by means of the radiant-tube heating device 4 for maintaining a temperature in a range from 780 to 920° C.

The transverse-flow induction heating device 12 is kept pressurized by means of a flow of a nitrogen and hydrogen mixture, which is preferably the same mixture which protects from oxidation in the zone of the radiant-tube heating device 4.

Downstream of the transverse-flow induction heating device 12, or downstream of the radiant-tube heating device 4, if present, the strip is cooled in the cooling zone 6 to a suitable temperature for immersion into the tank 8 containing the molten metal bath for coating the strip.

When using the second embodiment of the heating and annealing apparatus, shown in FIGS. 5, 5a, 5b and 5c, a pickled or cold-rolled strip is heated, by means of the longitudinal-flow induction heating device 10, from room temperature to a temperature lower than the Curie temperature of the material of the strip.

For example, the strip, preferably made of low carbon steel or stainless steel of the ferritic type, is heated at a temperature in a range from 680 to 740° C., preferably from 700 to 730° C., optionally with a heating gradient from 50 to 500° C./s, preferably from 80 to 400° C./s.

Downstream of the longitudinal-flow induction heating device 10, preferably immediately downstream of the device 10, the strip passes in the compensation zone 23 for making the temperature thereof uniform, in particular in transverse direction, e.g., at about 700-730° C.

Downstream of the compensation zone 23, preferably immediately downstream of said compensation zone 23, the strip is heated, by means of the transverse-flow induction heating device 12, at a temperature higher than the Curie temperature of the material of the strip.

For example, the strip is heated to a target temperature or final annealing temperature, preferably in a range from 750 to 950° C., preferably from 850 to 950° C., optionally with a heating gradient from 50 to 500° C./s, preferably from 80 to 400° C./s.

Preferably, the transverse-flow induction heating device 12 is activated when the temperature of the strip exiting from the longitudinal-flow induction heating device 10 is close to the Curie temperature.

Downstream of the transverse-flow induction heating device 12, preferably immediately downstream of said device 12, the strip passes in the maintaining zone 24 for maintaining the strip at said target temperature, preferably for a period of time from 5 to 60 seconds, and obtaining the complete re-crystallization of the material reaching the dimensions of the grains expected for the quality of steel to be produced.

Downstream of the maintaining zone 24, preferably immediately downstream of said maintaining zone 24, the strip is cooled in the cooling zone 6 down to a suitable temperature, e.g., in a range from 420 to 480° C., for immersion into the tank 8 containing the molten metal bath for coating the strip.

In a particular variant of the process, the strip is
heated by means of the longitudinal-flow induction heating device 10 at a temperature in a range from 700 to 730° C.,
caused to pass through the compensation zone 23 for making the temperature thereof uniform, in particular in transverse direction,
heated by means of the transverse-flow induction heating device 12 to a target temperature in a range from 850 to 950° C.,
caused to pass in the maintaining zone 24 for maintaining the strip at said target temperature.

When using the variant in FIG. 5a of the second embodiment, the difference with respect to the process carried out with the diagram in FIG. 5 is represented by the fact that the pickled or cold-rolled strip is pre-heated, by means of the pre-heating zone 27, from room temperature to a temperature from 70 to 90° C., for example. In particular, part of a technical gas present in the cooling zone 6 is conveyed towards the pre-heating zone 27, by means of a conduit 28 connecting the cooling zone 6 to said pre-heating zone 27.

Similarly, when using the variant in FIG. 5b of the second embodiment, the difference with respect to the process carried out with the diagram in FIG. 5 is represented by the fact that the pickled or cold-rolled strip is pre-heated, by means of the pre-heating zone 27, from room temperature to a temperature from 70 to 90° C., for example. In particular, a heat transfer fluid carried by a conduit 30 crosses the pre-heating zone 27 for pre-heating the strip. In the case of using steam or another pressurized heat transfer fluid, the strip can also reach a temperature of about 180-220° C. in said pre-heating zone 27.

In both variants in FIGS. 5a-5b, downstream of the pre-heating zone 27 the strip directly enters the longitudinal-flow induction heating device 10 where it is heated from a temperature of 70 to 90° C., or from 180 to 220° C., to a temperature lower than the Curie temperature of the material of the strip, e.g., at a temperature in a range from 680 to 740° C., preferably from 700 to 730° C.

When using the variant in FIG. 5c of the second embodiment, the difference with respect to the process carried out with the diagram in FIG. 5 is represented by the fact that the pickled or cold-rolled strip is pre-heated by means of the first pre-heating zone 32, from room temperature to a temperature in a range from 100 to 120° C., and by means of the next second pre-heating zone 33 to a temperature in a range from 450 to 500° C. In particular, part of a technical gas present in the cooling zone 6 is conveyed towards the first pre-heating zone 32 by means of a first conduit 34 connecting the cooling zone 6 to the first pre-heating zone 32; and a heat transfer fluid carried by a second conduit 35 crosses the second pre-heating zone 33 for further pre-heating the strip.

Downstream of the second pre-heating zone 33 the strip directly enters the longitudinal-flow induction heating device 10 where it is heated from a temperature of 450 to 500° C. to a temperature lower than the Curie temperature of the material of the strip, e.g., at a temperature in a range from 680 to 740° C., preferably from 700 to 730° C.

When using the third embodiment of the heating and annealing apparatus, shown in FIGS. 6, 6a, 6b and 6c, a pickled or cold-rolled strip is heated, by means of the longitudinal-flow induction heating device 10, from room temperature to a temperature lower than the Curie temperature of the material of the strip.

For example, the strip, preferably made of low carbon steel or stainless steel of the ferritic type, is heated at a temperature in a range from 680 to 740° C., preferably from 700 to 730° C., optionally with a heating gradient from 50 to 500° C./s, preferably from 80 to 400° C./s.

Downstream of the longitudinal-flow induction heating device 10, preferably immediately downstream of the device 10, the strip is heated, by means of the first transverse-flow induction heating device 12, to a temperature higher than the Curie temperature of the material of the strip.

For example, the strip is heated at a temperature in a range from 750 to 850° C., preferably from 750 to 800° C., optionally with a heating gradient from 50 to 500° C./s, preferably from 80 to 400° C./s.

Preferably, the first transverse-flow induction heating device 12 is activated when the temperature of the strip exiting from the longitudinal-flow induction heating device 10 is close to the Curie temperature.

Downstream of the first transverse-flow induction heating device 12, preferably immediately downstream of the device 12, the strip passes in the compensation zone 23 for making the temperature thereof uniform, in particular in a transverse direction, e.g., at about 750-780° C.

Downstream of the compensation zone 23, preferably immediately downstream of said compensation zone 23, the strip is heated, by means of the second transverse-flow induction heating device 12′, to a target temperature or final annealing temperature, preferably in a range from 800 to 950° C., preferably from 810 to 900° C.

Downstream of the second transverse-flow induction heating device 12′, preferably immediately downstream of said device 12', the strip passes in the maintaining zone 24 for maintaining the strip at said target temperature, preferably for a time from 5 to 60 seconds, and obtaining the complete re-crystallization of the material reaching the dimensions of the grains expected for the quality of steel to be produced.

Downstream of the maintaining zone 24, preferably immediately downstream of said maintaining zone 24, the strip is cooled in the cooling zone 6 down to a suitable temperature, e.g., in a range from 420 to 480° C., for immersion into the tank 8 containing the molten metal bath for coating the strip.

In a particular variant of the process, the strip is
heated by means of the longitudinal-flow induction heating device 10 at a temperature in a range from 700 to 730° C.,
heated by means of the first transverse-flow induction heating device 12 to a target temperature in a range from 750 to 800° C.,
caused to pass through the compensation zone 23 for making the temperature thereof uniform, in particular in a transverse direction,
heated by means of the second transverse-flow induction heating device 12′ to a target temperature in a range from 810 to 900° C.,
caused to pass in the maintaining zone 24 for maintaining the strip at said target temperature.

When using the variant in FIG. 6a of the third embodiment, the difference with respect to the process carried out with the diagram in FIG. 6 is represented by the fact that the pickled or cold-rolled strip is pre-heated, by means of the pre-heating zone 27, from room temperature to a temperature, e.g., from 70 to 90° C. In particular, part of a technical gas present in the cooling zone 6 is conveyed towards the pre-heating zone 27, by means of a conduit 28 connecting the cooling zone 6 to said pre-heating zone 27.

Similarly, when using the variant in FIG. 6b of the third embodiment, the difference with respect to the process carried out with the diagram in FIG. 6 is represented by the fact that the pickled or cold rolled strip is pre-heated, by means of the pre-heating zone 27, from room temperature to a temperature, e.g., from 70 to 90° C. In particular, a heat transfer fluid carried by a conduit 30 crosses the pre-heating zone 27 for pre-heating the strip.

In the case of using steam or another pressurized heat transfer fluid, the strip can also reach a temperature of about 180-220° C. in said pre-heating zone 27.

In both variants in FIGS. 6a-6b, downstream of the pre-heating zone 27 the strip directly enters the longitudinal-flow induction heating device 10 where it is heated from a temperature of 70 to 90° C., or from 180 to 220° C., to a temperature lower than the Curie temperature of the material of the strip, e.g., to a temperature in a range from 680 to 740° C., preferably from 700 to 730° C.

When using the variant in FIG. 6c of the third embodiment, the difference with respect to the process carried out with the diagram in FIG. 6 is represented by the fact that the pickled or cold rolled strip is pre-heated by means of the first pre-heating zone 32, from room temperature to a temperature in a range from 100 to 120° C., and by means of the next second pre-heating zone 33 up to a temperature in a range from 450 to 500° C. In particular, part of a technical gas present in the cooling zone 6 is conveyed towards the first pre-heating zone 32 by means of a first conduit 34 connecting the cooling zone 6 to the first pre-heating zone 32; and a heat transfer fluid carried by a second conduit 35 crosses the second pre-heating zone 33 for further pre-heating the strip.

Downstream of the second pre-heating zone 33 the strip directly enters the longitudinal-flow induction heating device 10 where it is heated from a temperature of 450 to 500° C. to a temperature lower than the Curie temperature of the material of the strip, e.g., at a temperature in a range from 680 to 740° C., preferably from 700 to 730° C.

In both the second and third embodiments, in the possible absence of one or more pre-heating zones, a surface cleaning of the strip is provided upstream of the at least one longitudinal-flow induction heating device 10, e.g., by means of an alkaline cleaning section.

Moreover, the annealing apparatus can be entirely pressurized by technical gases, such as nitrogen, hydrogen or a mixture thereof, which ensure protection from oxidation and a cleaning/reducing action.

1. An annealing apparatus for a metal strip advancing along a longitudinal direction into a coating system for coating said metal strip with a layer of molten metal, said apparatus comprising, in sequence
at least one longitudinal-flow induction heating device;
at least one transverse-flow induction heating device;
at least one cooling zone;
wherein there is provided at least one pre-heating zone arranged upstream of said longitudinal-flow induction heating device.

2. The apparatus according to claim 1, wherein only one longitudinal-flow induction heating device and only one transverse-flow induction heating device are provided.

3. The apparatus according to claim 1, wherein there are provided
an open-flame heating device arranged between said longitudinal-flow induction heating device and said transverse-flow induction heating device;
preferably, a radiant-tube heating device arranged downstream of said transverse-flow induction heating device.

4. The apparatus according to claim 3, wherein a conduit for conveying fumes produced by said open-flame heating device into said pre-heating zone is provided, said conduit by-passing said longitudinal-flow induction heating device.

5. The apparatus according to claim 1, wherein there are provided
a maintaining zone arranged downstream of said transverse-flow induction heating device for maintaining a predetermined temperature;
and a compensation zone arranged between said longitudinal-flow induction heating device and said transverse-flow induction heating device for making a temperature of the metal strip exiting from said longitudinal-flow induction heating device uniform;
or wherein there are provided
a first transverse-flow induction heating device, arranged downstream of said longitudinal-flow induction heating device;
a compensation zone, arranged downstream of said first transverse-flow induction heating device, for making the metal strip temperature uniform;
a second transverse-flow induction heating device, arranged downstream of said compensation zone;
a maintaining zone, arranged downstream of said second transverse-flow induction heating device.

6. (canceled)

7. The apparatus according to claim 5, wherein the maintaining zone is provided with first electric radiant elements; wherein the compensation zone is preferably provided with second electric radiant elements; preferably, wherein said electric radiant elements are resistor spark plugs or tubes.

8. The apparatus according to claim 5, wherein a conduit connects the at least one cooling zone to said pre-heating zone for conveying part of a technical gas present in said cooling zone towards the pre-heating zone or wherein a conduit adapted to carry a heat transfer fluid, crosses the pre-heating zone for pre-heating the metal strip.

9. The apparatus according to claim 5, wherein a first pre-heating zone and a second pre-heating zone are provided upstream of said longitudinal-flow induction heating device ; preferably, wherein a first conduit connects the at least one cooling zone to the first pre-heating zone for conveying part of a technical gas present in said cooling zone towards the first pre-heating zone and wherein a second conduit adapted to carry a heat transfer fluid, crosses the second pre-heating zone (33) for further pre-heating the metal strip.

10. The apparatus according to claim 1, wherein said longitudinal-flow induction heating device comprises at least one induction coil wrapped transversely about a metal strip advancement plane; preferably, wherein there are provided pairs of guide rollers preferably coated with ceramic material, for guiding and supporting the metal strip upstream and downstream of the at least one induction coil; preferably, wherein there are provided temperature sensors for detecting a temperature of the metal strip entering into and exiting from said longitudinal-flow induction heating device; preferably, wherein said at least one induction coil is connected to a capacitor bank and a high frequency converter

11. The apparatus according to claim 1, wherein said transverse-flow induction heating device comprises at least one pair of induction coils consisting of a first induction coil arranged at a first side of a metal strip advancement plane, and a second induction coil arranged at a second side of said metal strip advancement plane, opposite to the first side; preferably, wherein there is provided at least one movement actuator for moving at least one of the first induction coil and the second induction coil transversely to said longitudinal direction or wherein the first induction coil and the second induction coil are fixed and there is provided at least one movement actuator for moving movable screens, preferably arranged above the first induction coil and below the second induction coil respectively; preferably, wherein there are provided position sensors for detecting a position of edges of the metal strip with respect to a center line of said metal strip advancement plane.

12. The apparatus according to claim 10, wherein there are provided pairs of guide rollers preferably coated with a ceramic material, for guiding and supporting the metal strip upstream and downstream of said at least one pair of induction coils; preferably, wherein there are provided temperature sensors for detecting the temperature of the metal strip entering into and exiting from said transverse-flow induction heating device preferably, wherein the first induction coil and the second induction coil are connected to a respective capacitor bank and to a respective high frequency converter.

13. A process for annealing a pickled or cold-rolled metal strip, advancing along a longitudinal direction into a coating system for coating said metal strip with a layer of molten metal, the process being carried out by an apparatus according to claim 1 and comprising the following steps:
a) heating the metal strip by means of said at least one longitudinal-flow induction heating device at a temperature lower than the Curie temperature of a material of the metal strip;
b) heating the metal strip by means of said at least one transverse-flow induction heating device, at a temperature higher than the Curie temperature of the material of the metal strip;
c) cooling the metal strip by means of said at least one cooling zone;
wherein a pre-heating of the metal strip is provided in said at least one pre-heating zone upstream of said longitudinal-flow induction heating device.

14. The process according to claim 13, wherein, when there are provided
an open-flame heating device preferably supplied with natural gas, for further heating the metal strip, arranged between said longitudinal-flow induction heating device and said transverse-flow induction heating device;
preferably a radiant-tube heating device preferably supplied with natural gas, arranged downstream of said transverse-flow induction heating device for maintaining a temperature reached in said transverse-flow induction heating device;
fumes produced by said open-flame heating device are conveyed through a conduit directly into said pre-heating zone for pre-heating the metal strip, preferably at a temperature in a range from 50 to 200° C., said conduit bypassing said longitudinal-flow induction heating device.

15. The process according to claim 13, wherein, between the at least one longitudinal-flow induction heating device and the at least one transverse-flow induction heating device the strip passes in a compensation zone for making the metal strip temperature uniform, in particular in a transverse direction;
and wherein, downstream of the transverse-flow induction heating device the metal strip passes into a maintaining zone for maintaining the metal strip at a target temperature, reached by means of the transverse-flow induction heating device until a complete re-crystallization of the metal strip is obtained.

16. The process according to claim 13, wherein step b) includes:
a heating of the metal strip, by means of a first transverse-flow induction heating device to a temperature higher than the Curie temperature of a material of the metal strip;
a passage of the metal strip through a compensation zone for making the metal strip temperature uniform, in particular in a transverse direction;
a further heating of the metal strip, by means of a second transverse-flow induction heating device, to a target temperature;
a passage of the metal strip in a maintaining zone for maintaining the metal strip at said target temperature until a complete re-crystallization of the metal strip is obtained.

17. The process according to claim 15, wherein part of a technical gas present in said cooling zone is conveyed towards the pre-heating zone by means of a conduit which connects the at least one cooling zone to said pre-heating zone or wherein a heat transfer fluid, carried by a conduit crosses the pre-heating zone for pre-heating the metal strip;
or wherein, when a first pre-heating zone and a second pre-heating zone are provided upstream of said longitudinal-flow induction heating device part of a technical gas present in said cooling zone is conveyed towards the first pre-heating zone by means of a first conduit which connects the at least one cooling zone to the first pre-heating zone and a heat transfer fluid, carried by a second conduit crosses the second pre-heating zone for further pre-heating the metal strip.

18. A system for coating a metal strip with a layer of molten metal comprising an annealing apparatus according to claim 1.
